(19) United States
(12) Patent Application Publication
(10) Pub. No.: US 2009/0109330 A1
(43) Pub. Date: Apr. 30, 2009

(54) Case member, sensor module, and electronic information device

(76) Inventors: Takahiko Nakano, Hiroshima (JP); Toshiharu Inui, Nara (JP); Hidetoshi Nishimura, Nara (JP)

Correspondence Address: Edwards Angell Palmer & Dodge LLP, P.O. Box 55874, Boston, MA, 02205, US

(21) Appl. No.: 12/289,232

(22) Filed: Oct. 23, 2008

(30) Foreign Application Priority Data
Oct. 24, 2007 (JP) 2007-277008

(51) Int. Cl. H04N 5/225

(52) U.S. Cl. 348/374; 348/E05.026

(57) ABSTRACT

A case member has a predetermined surface and a sealable inside, where a first circular area for passing light is provided at the center portion of the predetermined surface, a double-sided light shielding sheet, which is provided with a second circular area for passing light at the center, is adhered to the predetermined surface such that the second circular area is positioned in a concentric circle manner to the first circular area, the second circular area having a diameter smaller than the diameter of the first circular area, a transparent dustproof film is adhered on the light shielding sheet.

This nonprovisional application claims priority under 35 U.S.C. §119(a) to Patent Application No. 2007-277008 filed in Japan on Oct. 24, 2007, the entire contents of which are hereby incorporated by reference.

### BACKGROUND OF THE INVENTION

1. Field of the Invention

The present invention relates to a sensor module equipped with a solid-state image capturing chip for performing photoelectric conversions on and capturing image light from a subject, a case member used for the sensor module, and an electronic information device, such as a digital camera (e.g., digital video camera and digital still camera), an image input camera (e.g., an onboard camera), a scanner, a facsimile machine, and a camera-equipped cell phone device, using the sensor module as an image input device in an image capturing section.

2. Description of the Related Art

With respect to a conventional module of this type, a solid-state image capturing chip is encased in a package composed of a substrate of epoxy resin with ceramics and glass and a case member of plastic, metal and the like, the solid-state image capturing chip being a solid-state image capturing apparatus provided with a plurality of photoelectric conversion elements (a plurality of light receiving sections) for performing photoelectric conversions on and capturing image light from a subject.

FIG. 7 is a longitudinal cross sectional view schematically illustrating an exemplary essential structure of a conventional sensor module. FIG. 8 is a longitudinal cross sectional view schematically illustrating an exemplary essential structure of a case member used for the sensor module in FIG. 7.

In FIGS. 7 and 8, a conventional sensor module 80 includes a dustproof case member 81, a focusing lens 82, a VCM (voice coil motor) 83 for moving the focusing lens 82 vertically, a substrate 84, a solid-state image capturing chip 86 provided on the substrate 84, and an infrared rays (IR) cut filter 87 for omitting infrared light out of incident light from the focusing lens 82.

The dustproof case member 81 includes a case 811 for covering the focusing lens 82, VCM (voice coil motor) 83, solid-state image capturing chip 86 and the IR cut filter 87 further thereabove, with the substrate 84 to seal the inside; a dustproof film 813 provided on an upper surface of the case 811 interposed therebetween with an adhesive layer 812; and a light shielding film 815 (light shielding sheet) provided on the dustproof film 813 interposed therebetween with an adhesive layer 814.

The case 811 is constituted of a metal box-type casing (metal casing) so as to be thin in thickness, and to be capable of shielding the inside from light and sealing it. The case 811 is provided with a circular hole 811a for allowing light to enter the focusing lens 82, the circular hole being formed at the center portion of the upper surface.

The dustproof film 813 is formed of a transparent resin material and the like, which does not affect its optical characteristics, and is adhered to an upper surface of the case 811 by the adhesive layer 812.

The light shielding film 815 is provided with a circular hole 815a provided on the center portion of the upper surface, the circular hole 815a corresponding in a concentric circle manner to the circular hole 811a at the center portion of the upper surface of the case 811. The light shielding film 815 is adhered to the dustproof film 813 by the adhesive layer 814.

The focusing lens 82 is for focusing incident light on an image capturing area of the solid-state image capturing chip 86, the focusing lens being held by a fixing and holding member 88.

The VCM (voice coil motor) 83 is a driving source for vertically moving the focusing lens 82 held by the fixing and holding member 88, for focusing the lens on the image capturing area of the solid-state image capturing chip 86. For example, when a subject is at infinity, the fixing and holding member 88 and focusing lens 82 are positioned at the lower most position by the empty weight, and the VCM (voice coil motor) 83 drives the focusing lens 82 together with the fixing and holding member 88 upwards in accordance with the distance to the subject so as to focus it on the image capturing area.

Herein, as described above, the dustproof film 813 and the light shielding film 815 are adhered in this order on an upper surface of a metal casing (case 811).

On the other hand, with regard to capturing a subject (capturing by the solid-state image capturing chip 86 in the case of FIG. 8), an incident route for light is limited by using a light shielding member and a light shielding sheet (the circular hole 815a of the light shielding film 815 in the case of FIG. 8) in order to prevent the image quality from decreasing due to flare. For such a case, Reference 1 discloses a technique to form a light shielding member on a lens in a fixing manner. In addition, Reference 2 discloses a technique to contrive a shape of a hole in a light shielding member to prevent flare. In these prior techniques, the main goal is to achieve shielding of light at a low cost. This light shielding member will be discussed further.

FIG. 9 is a cross sectional view of a conventional sensor module disclosed in Reference 1.

In FIG. 9, a conventional sensor module 100 includes a substrate 101, a solid-state image capturing chip 102 functioning as a solid-state image capturing apparatus provided on the substrate, a case 103 for covering and sealing the solid-state image capturing chip 102 on the substrate 102, a focusing lens 104 provided on the case 103 in a facing manner to an image capturing area of the solid-state image capturing chip 102, an IR cut filter 105, and an aperture mask 106 above the IR cut filter 105.

The solid-state image capturing chip 102 is die-bonded on the substrate 101, and a pad of the solid-state image capturing chip 102 and a pattern of the substrate 101 are wire-bonded by a wire 107. In the solid-state image capturing chip 102, an image capturing circuit is positioned as a solid-state image capturing apparatus, the image capturing circuit being configured with a signal generating component, which is a photoelectric conversion element (e.g., a plurality of photodiodes), a signal transferring component constituted of a CCD element, and a signal detecting component constituted of a MOS transistor.

The case 103 is in a box-shape on the lower side and is a cylinder on the upper side. A shelf 103a is formed on an inner wall of the cylinder portion on the upper side of the case 103, and a focusing lens 104 is positioned on the shelf 103a from the top. An IR (infrared rays) cut filter 105 is overlapped and positioned on the focusing lens 104. The IR cut filter 105 is positioned on the focusing lens 104, facing the image capturing area of the solid-state image capturing chip 102 above the substrate 101, thereby preventing an image from being white due to the saturation of electric charges in an environment with many infrared rays, such as the outdoors.

An aperture mask 106 covers the IR cut filter 105, the aperture mask 106 functioning as a light shielding member and being provided with a light passing hole 106a provided at the center portion for passing light. Although the aperture mask 106 functioning as a light shielding member is positioned above the IR cut filter 105, the aperture mask 106 may be reversed and positioned below the IR cut filter 105. In this way, the aperture mask 106 adheres closely to the focusing lens 104 and there will be no separation with the focusing lens 104, thereby being effective against flare.

FIG. 10 is a cross sectional view illustrating a portion of an optical system in a camera section of a conventional image capturing apparatus disclosed in Reference 2.

In an optical system 200 in a camera section of a conventional image capturing apparatus in FIG. 10, a CCD image capturing element 203 and a focusing lens 204 are attached with a predetermined distance provided in between each other in a cylinder-shaped inner space 202 provided in a casing structure 201 formed of a synthetic resin and metal. As illustrated with a white arrow A, there is a light passing course for the light to pass from the side of the focusing lens 204 to the CCD image capturing element 203. A frame 205, which projects from the casing structure 201 to the cylinder-shaped inner space 202, is provided in between the focusing lens 204 and the CCD image capturing element 203. Such frame 205 is provided for the purpose of attaching and for determining the position of the parts, and reinforcing structures.

The frame 205 projecting to the cylinder-shaped inner space 202 crosses at right angles with the light passing course illustrated with a white arrow A. If a portion of light reflects on a side surface of the frame 205 and returns to the focusing lens 204 side, a problem of interference with incident light to be captured or a problem to have a bad influence as a noise occurs. A problem due to the reflection of light may also occur in the inner circumference terminal surface of frame 205.

Light shielding members 206a and 206b are attached to the side surface of the frame 205. They are adhered and fixed by pressing an adhesive layer 207 to the side surface of the frame 205. The shapes of the inner and outer circumferences of the light shielding members 206a and 206b substantially correspond to the shape of the side surface of the frame 205. As a result, a harmful reflection of light can be prevented at the side surface of the frame 205. The light which is about to pass outside a light passing aperture 208a of a light shielding piece 208 is shielded by the light shielding piece 208. The light passing aperture 208a, that is an inner circumference edge of the light passing aperture 208a, is positioned slightly towards the center side than the inner circumference terminal surface of the frame 205, so that the reflection of light can be reduced at the inner circumference terminal surface of the frame 205, as well.

The terminal surfaces of the inner and outer circumferences of the adhesive layer 207 are positioned inside the terminal surfaces of the inner and outer circumferences of the light shielding piece 208, so that it is difficult for a foreign substance, such as dust, to adhere to the terminal surface of the adhesive layer 207. Even if such a foreign substance adheres to the adhesive layer 207, the passing of light is rarely hindered if the adhesive layer 207 is positioned inside the light shielding piece 208.

Further, the inner circumference of the light passing aperture 208a is a taper surface that opens outside (opposite direction of the white arrow A) and the inner circumference edge of the taper surface is a substantially pointed linear shape having substantially no width. Therefore, the reflection of light at the inner circumference of the light passing aperture 208a can be prevented, which harmfully influences the CCD image capturing element 203. The taper surface of the light passing aperture 208a is configured to be narrower (the diameter is reduced) towards the light passing direction (white arrow A). The light shielding piece 208 has a function to prevent the reflection of light not only on the surface but also on the terminal surface, so that the reflection of light towards the inside is also prevented at the taper surface of the light passing aperture 208a.

Reference 1: Japanese Laid-Open Publication No. 2004-88181

Reference 2: Japanese Laid-Open Publication No. 2006-85026

### SUMMARY OF THE INVENTION

However, a moving part will be required, which vertically moves the fixing and holding member 88 together with the focusing lens 82 by the VCM (voice coil motor) 83, in order to achieve an autofocus (AF) function in the conventional structure described above. Due to this, it will be difficult to seal the inside of the sensor module 80. If the inside of the sensor module 80 cannot be sealed completely, dust enters the casing, which may cause the deterioration of the image quality.

Further, it is necessary for the downsizing of the sensor module 80 to adopt a metal material for the case 811, which is a casing having a motor built-in, from the point of the thin thickness and the shielding of light. However, if the casing is coated with paint, it is required to connect the ground of a radio device (e.g., a cell phone device) functioning as an electronic information device and the ground of the sensor module 80, and the connection becomes poor, resulting in the disadvantage of an unstable electric potential for the design of a small radio device. Therefore, the casing is not coated with paint, and instead, a light shielding film is used on an upper surface of the casing to prevent the reflection of light from the metal casing (inner surface of a light passing hole, in particular).

As a result, the dustproof film 813 and light shielding film 815 are adhered on the upper surface of the metal casing (case 811) in a conventional way. Therefore, the accuracy is required to adhere the dustproof film 813 and light shielding film 815 and the manufacturing steps would increase, which leads to a cost issue. Further, this conventional manner leads to the increase of the thickness, resulting in the increase of the height and the reverse movement for downsizing.

Similarly, although techniques to use a light shielding member are disclosed is References 1 and 2, the manufacturing steps increase and process accuracy and cost issues still remain in these techniques as well. Further, the thickness increases, resulting in the reverse movement for downsizing. The problem against a low profile is yet to be solved.

Although Reference 1 discloses a technique to provide a light shielding film on a lens surface side, this technique is with regard to an example with a fixed focal point with no moving part included, and no function for preventing dust from entering. In, the reference, the light shielding film is used only to be added to the focusing lens 104 and the IR cut filter 105, and such a technique will not be a way to prevent the reflection of light from a metal casing.

In Reference 2, although a light shielding member has an inner circumference side surface of the light passing aperture 208a, which is a taper surface that opens outside, to provide an effect to allow the reflection of light towards the outside, the object is the reflection occurred in the light passing course. The reflection of incident light cannot be prevented from the metal casing (reflection by the inner circumference side surface of a light passing hole of the case). Further, the function for preventing dust from entering is not included.

The present invention is intended to solve the conventional problems described above. The objective of the present invention is to provide a case member, which is capable of reducing the manufacturing steps to reduce the cost as well as achieving low profiling and downsizing, and capable of preventing the reflection of light from a light passing hole of a dust-preventing metal casing in a sensor module having an AF function with a moving part built-in; a sensor module using the case member to seal a solid-state image capturing chip; and an electronic information device using the sensor module as an image input device, such as an onboard camera and a camera-equipped cell phone device.

A case member according to the present invention has a predetermined surface and a sealable inside; wherein a first circular area for passing light is provided at the center portion of the predetermined surface, wherein a double-sided light shielding sheet, which is provided with a second circular area for passing light at the center, is adhered to the predetermined surface such that the second circular area is positioned in a concentric circular manner to the first circular area, the second circular area having a diameter smaller than the diameter of the first circular area, and wherein a transparent dustproof film is adhered on the light shielding sheet, thereby achieving the objective described above.

Preferably, in a case member according to the present invention, the light shielding sheet has a reflection preventing function.

Still preferably, in a case member according to the present invention, the light shielding sheet is in a black color or a dark color.

Still preferably, in a case member according to the present invention, the light shielding sheet is configured with a surface having an uneven form for diffused reflection.

Still preferably, in a case member according to the present invention, the light shielding sheet is in a single color or is drawn in a pattern.

Still preferably, in a case member according to the present invention, the pattern is such that the single black color becomes incrementally or continuously thinner or darker in a multiple concentric circle manner.

Still preferably, in a case member according to the present invention, the pattern is such that a plurality of concentric circles having different diameters are drawn in a striped appearance.

Still preferably, in a case member according to the present invention, the first circular area and/or the second circular area is a first circular hole for passing light.

Still preferably, in a case member according to the present invention, the first circular area and/or the second circular area is a transparent first circular area for passing light.

Still preferably, in a case member according to the present invention, the second circular area of the light shielding sheet is a second circular hole for passing light that has a diameter for preventing the occurrence of a flare.

Still preferably, in a case member according to the present invention, the second circular area of the light shielding sheet is a transparent second circular area for passing light that has a diameter for preventing the occurrence of a flare.

Still preferably, in a case member according to the present invention, an inner circumference surface of the second circular hole of the light shielding sheet is configured with a taper surface that reduces its diameter in a direction to which incident light enters.

Still preferably, in a case member according to the present invention, the sum of the thicknesses of the light shielding sheet and the dustproof film is configured to be equal to or thinner than 0.22 mm.

Still preferably, in a case member according to the present invention, the thickness of the light shielding sheet is in the range of 0.03 to 0.10 mm.

Still preferably, in a case member according to the present invention, the thickness of the dustproof film is in the range of 0.05 to 0.15 mm.

Still preferably, a case member according to the present invention has a case which is a metal box or metal cylinder.

Still preferably, in a case member according to the present invention, the predetermined surface is an upper surface of the case, the upper surface and the four side surfaces connected to the upper surface are provided, and the lower surface is open.

A sensor module according to the present invention includes a solid-state image capturing chip provided on a substrate, for performing photoelectric conversions on and capturing image light from a subject, the solid-state image capturing chip encased inside the case member to be sealed by the case member and substrate according to the present invention, thereby achieving the objective described above.

Preferably, in a sensor module according to the present invention further includes a moving part capable of driving the focusing lens close to and far away from the image capturing area in order to adjust the focal point to the image capturing area of the solid-state image capturing chip, and a driving section for driving the moving part.

Still preferably, a sensor module according to the present invention is provided with an infrared rays cut filter for cutting infrared rays from incident light from the focusing lens in such a manner to cross between the solid-state image capturing chip and the moving part.

An electronic information device according to the present invention uses the sensor module according to the present invention as an image input device in an image capturing section.

The functions of the present invention having the structures described above will be described hereinafter.

According to the present invention, a first circular area for passing light is provided at the center portion of a predetermined surface of a case body. A double-sided adhesive, light shielding sheet has a second circular area for passing light, which is smaller than the first circular area, provided at the center portion. The light shielding sheet is adhered on the predetermined surface in such a manner that the second circular area is positioned concentrically with the first circular area. Further, a transparent dust-preventing film is adhered on the light shielding sheet.

As described above, a transparent dust-preventing film is adhered on such a predetermined surface of the case body using the double-sided adhesive light shielding sheet so as to achieve reducing the manufacturing steps to reduce the cost as well as achieving low profiling and downsizing. The diameter of the second circular area of the light shielding sheet is smaller than the diameter of the first circular area of the case body, and the second circular area of the light shielding sheet is located above the first circular area of the case body. Therefore, the reflection of light can be prevented from the inner circumference side surface of the first circular area of the case body.

In such a case, the light shielding sheet has a black or dark color for reflection preventing function. Alternatively, the surface of the light shielding sheet is configured in an uneven form for diffused reflection. As a result, the light shielding sheet is effective against flare in addition to having a light shielding function.

In addition, the light shielding sheet has either a single color or a pattern. The light shielding sheet will look like it is recessed when the single color becomes lighter incrementally or continuously in a multiple concentric circle manner. The light shielding sheet will look like it is protruded when the single color becomes darker incrementally or continuously in a multiple concentric circle manner. The light shielding sheet will look like it has a sense of good quality or luxuriousness when a plurality of concentric circles with different diameters are drawn as a pattern in a striped appearance.

Further, the first circular area on a predetermined surface of the case body or the second circular area of the light shielding sheet may be transparent circular areas other than holes.

According to the present invention with the configuration above, a transparent dust-preventing film is adhered on such a predetermined surface of the case body using the double-sided adhesive light shielding sheet so as to achieve reducing the manufacturing steps to reduce the cost as well as achieving low profiling and downsizing, as compared to the conventional way. Further, the second circular area of the light shielding sheet is located above the first circular area of the case body, and the diameter of the second circular area of the light shielding sheet is smaller than the diameter of the first circular area of the case body, so that the reflection of light can be prevented from the inner circumference side surface of the first circular area of the case body.

These and other advantages of the present invention will become apparent to those skilled in the art upon reading and understanding the following detailed description with reference to the accompanying figures.

### BRIEF DESCRIPTION OF THE DRAWINGS

FIG. 1 is a longitudinal cross sectional view schematically illustrating an exemplary essential structure of a sensor module according to Embodiment 1 of the present invention.

FIG. 2 is a longitudinal cross sectional view schematically illustrating an exemplary essential structure of a case member used for the sensor module in FIG. 1.

FIG. 3 is a longitudinal cross sectional view schematically illustrating an exemplary essential structure of a case member used for a sensor module according to Embodiment 2 of the present invention.

FIG. 4 is a plan view of the case member in FIG. 3.

FIG. 5 is a perspective view schematically illustrating an exemplary essential structure of a case member used for a sensor module according to Embodiment 3 of the present invention.

FIG. 6 is a plan view of the case member in FIG. 5.

FIG. 7 is a longitudinal cross sectional view schematically illustrating an exemplary essential structure of a conventional sensor module.

FIG. 8 is a longitudinal cross sectional view schematically illustrating an exemplary essential structure of a case member used for the sensor module in FIG. 7.

FIG. 9 is a cross sectional view of a conventional sensor module disclosed in Reference 1.

FIG. 10 is a cross sectional view illustrating a portion of an optical system in a camera section of a conventional image capturing apparatus disclosed in Reference 2.

FIG. 11 is a block diagram illustrating an exemplary diagrammatic structure of an electronic information device, such as car-mounted camera and camera-equipped cell phone device, as Embodiment 4 of the present invention, using the sensor module according to any of Embodiments 1 to 3 of the present invention as an image input device in an image capturing section.

1 case member
2 focusing lens
3 VCM (voice coil motor; driving section)
4 substrate
6 solid-state image capturing chip
7 IR cut filter
8 fixing member (resin casing)
9 outer wall of an electronic information device (decorated case)
11 case
11a circular hole (first circular hole)
12 dustproof film
13, 13A, 13B light shielding sheet
13a, 13b circular hole (second circular hole)
13c, 13d taper surface
10, 10A, 10B sensor module (camera module)
70 electronic information device
71 memory section
72 display section
73 communication section
74 image output section

### DESCRIPTION OF THE PREFERRED EMBODIMENTS

Hereinafter, a sensor module according to Embodiments 1 to 3 of the present invention, and the electronic information device of Embodiment 4 using the sensor module according to Embodiments 1 to 3 as an image input device in an image capturing section, will be described with reference to the accompanying figures.

### Embodiment 1

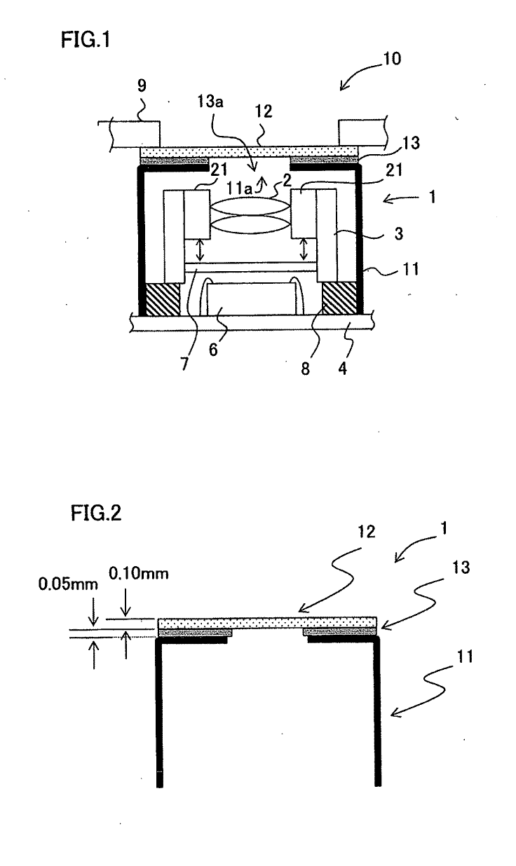

FIG. 1 is a longitudinal cross sectional view schematically illustrating an exemplary essential structure of a sensor module according to Embodiment 1 of the present invention. FIG. 2 is a longitudinal cross sectional view schematically illustrating an exemplary essential structure of a case member used for the sensor module in FIG. 1.

In FIG. 1, a sensor module 10 according to Embodiment 1 is a sensor module with a moving part inside and an AF function. The sensor module 10 includes a dust-preventing case member 1, a focusing lens 2, a VCM (voice coil motor) 3 functioning as a driving section for vertically moving the focusing lens 2, a substrate 4, a solid-state image capturing chip 6 provided on the substrate 4, and an IR cut filter 7. In addition, the reference numeral 8 denotes a fixing member, which is a resin casing, and the reference numeral 9 denotes a decorated case, which is an outer wall of an electronic information device, such as a cell phone device.

The dust-preventing case member 1 includes a case 11 for covering the focusing lens 2, VCM (voice coil motor) 3, solid-state image capturing chip 6 and IR cut filter 7 further thereabove, with the substrate 4 to seal the inside; a dustproof film 12 provided on an upper surface of the case 11; and a double-sided adhesive, light shielding film 13 (light shielding sheet) provided between the upper surface of the case 11 and the dustproof film 12. As described above, the solid-state image capturing chip 6 is encased by the case member 1 and the substrate 4 inside the case member 1 to be sealed, the solid-state image capturing chip 6 performing photoelectric conversions on and captures image light from a subject.

The case 11 is configured with a box-type casing (metal casing), which is made of a thin metal plate that is thin, yet capable of shielding and sealing the inside. The case 11 is provided with an upper surface and four side surfaces connected to the upper surface, and the lower surface is open. A circular hole 11a for passing incident light is formed on the upper surface, the circular hole 11a functioning as a first circular hole facing the focusing lens 2. The center of the circular hole 11a is positioned in such a manner that an optical axis of the focusing lens 2 passes it.

The dustproof film 12 is formed of a resin material and the like that does not affect the optical characteristics.

The light shielding film 13 is set to be black with a reflection preventing treatment and is a double-sided adhesive sheet having adhesiveness on both sides. The light shielding film 13 is provided at the center portion of the upper surface of the case 11 in such a manner that a circular hole 13a concentrically corresponds to a circular hole 11a, the circular hole 13a being a second circular hole for passing incident light that has a diameter smaller than the diameter of the circular hole 11a. The circular hole 13a of the light shielding sheet 13 is a circular hole for preventing the occurrence of a flare. That is, the circular hole 13a is set to have an opening diameter that will not produce a flare in view of the lens characteristics of the focusing lens 2. For example, the opening diameter is set such that an oblique light is radiated with an inclination of 50 to 60 degrees against a light in a vertical direction, and the level (diffusedly reflected noise level) of the image capturing signal due to the oblique light is smaller than a predetermined reference value (degree of roughness in a display screen).

As described above, with respect to the dustproof case member 1, the transparent dustproof film 12 is adhered to the upper surface of the metal case 11 using a black colored adhesive sheet (light shielding sheet 13) that has adhesiveness on both sides.

Conventionally with respect to FIG. 8, the thickness of the light shielding film 815 is 0.10 mm, and the thickness of the dustproof film 813 is 0.10 mm. Together with the adhesive layers 812 and 814, the total thickness will be 0.22 mm. In Embodiment 1, on the other hand, the thickness of the light shielding film 13 is 0.05 mm, and the thickness of the transparent dustproof film 12 is 0.10 mm. As a result, the total thickness is thirty-two percent thinner compared to the conventional case member in FIG. 8, the thickness being changed from the conventional 0.22 mm to 0.15 mm in accordance with Embodiment 1. Thereby, the case member 1 can be low profiled and downsized.

In short, it is all right as long as the total thickness of the light shielding film 13 and the dustproof film 12 is thinner than the conventional 0.22 mm. In this case, the thickness of the light shielding film 13 may be in the range of 0.03 to 0.10 mm, and the thickness of the dustproof film 12 may be in the range of 0.05 to 0.15 mm.

The focusing lens 2 is made of combining lenses for focusing light on the image capturing area of the solid-state image capturing chip 6, and the set of lenses is held by a fixing and holding member 21 so that the set is vertically movable.

The VCM (voice coil motor) 3 is a driving source (driving section) for vertically moving the focusing lens 2 held at the fixing and holding member 21 so that the focal point is adjusted on the image capturing area of the solid-state image capturing chip 6. A coil is positioned around the fixing and holding member 21 for the focusing lens 2. When a subject lies at infinity, for example, the moving part for the fixing and holding member 21 and focusing lens 2 is located at the lower most position, and the VCM (voice coil motor) 3 moves the focusing lens 2 together with the fixing and holding member 21 upwards in accordance with the position of the subject. As described above, such a moving part is provided, which can drive the focusing lens 2 close to and far away from the image capturing area in order to adjust the focal point to the image capturing area of the solid-state image capturing chip 6. The moving part is constituted of the fixing and holding member 21 and the focusing lens 2. In addition to the VCM (voice coil motor) 3, a piezoelectric element that utilizes vibration to vertically move an object as well as a stepping motor can be used as a driving section.

The solid-state image capturing chip 6 includes a solid-state image capturing apparatus, the solid-state image capturing apparatus having a plurality of photoelectric conversion sections (a plurality of light receiving sections) formed in a matrix therein for performing photoelectric conversions on and capturing image light from a subject. Such a solid-state image capturing apparatus can be applied for either a CMOS image sensor or a CCD image sensor. In the CMOS image sensor, a signal readout circuit, which is related to a selection of a photoelectric conversion section and a signal output from the photoelectric conversion section and which is connected to one another through a multilayer wiring layer, is provided for each unit pixel section. In the CCD image sensor, a plurality of photoelectric conversion sections are provided in two dimensions on a light receiving surface of the image capturing area. Further, a signal charge which is photoelectrically converted in a photoelectric conversion section is read out to a charge transfer section CCD and continuously transferred to a predetermined direction. Subsequently, the signal charge is continuously detected in a charge detection section at once instead of being detected at each light receiving section, and the signal charge is amplified as an image capturing signal to be output as a signal.

The infrared rays (IR) cut filter 7 crosses between the solid-state image capturing chip 6 and the moving part, and is fixed to a predetermined member (a base section of a main pillar member of the VCM (voice coil motor) 3 or the fixing member 8) so as to cut infrared rays from incident light from the focusing lens 2.

According to Embodiment 1 with the sensor module 10 having the moving part inside and having the AF function, the transparent dustproof film 12 is adhered to the upper surface of the metal case 11 using a black colored adhesive sheet (light shielding sheet 13) that has adhesiveness on both sides, instead of accurately adhering two films, such as a dustproof film and a light shielding film, on the upper surface of the case 11. As a result, the man-hour and the cost are reduced, and low profiling and downsizing are achieved. Further, the reflection of light can be prevented from the inner circumference side surface of the circular hole 11a of the dustproof case 11 when the circular hole 13a for passing incident light, which has a diameter smaller than the diameter of the circular hole 11a of the case 11, is provided at the center portion concentrically with the circular hole 11a.

### Embodiment 2

In Embodiment 1 described above, it has been described that the opening diameter of the circular hole 13a in the light shielding sheet 13 is set in such a manner that the diameter is smaller than the opening diameter of the circular hole 11a in the upper surface of the case 11, which is a metal casing, and further, that the diameter is set so as not to produce a flare in view of the lens characteristics of the focusing lens 2. In Embodiment 2, in addition to the configuration described above, the inner circumference side surface of the circular hole 13a of the light shielding sheet 13 is configured with a taper surface that reduces its diameter in a direction to which incident light enters.

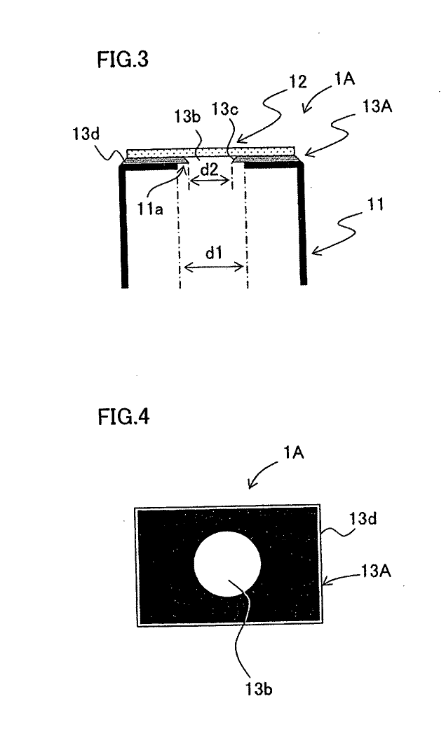

FIG. 3 is a longitudinal cross sectional view schematically illustrating an exemplary essential structure of a case member used for a sensor module according to Embodiment 2 of the present invention. FIG. 4 is a plan view of the case member in FIG. 3. In FIGS. 3 and 4, note that the same reference numeral is denoted as the member in FIG. 1 for a member that has the same function and effect. In addition, the configuration of the sensor module 10 in FIG. 1 can be applied to the case in FIGS. 3 and 4.

In FIGS. 3 and 4, a dustproof case member 1A in a sensor module according to Embodiment 2 is a sensor module having a moving part inside and an AF function. The dustproof case member 1A includes: a case 11 for covering a focusing lens 2, a VCM (voice coil motor) 3, a solid-state image capturing chip 6 and an IR cut filter 7 further thereabove, with a substrate 4 to seal the inside; a dustproof film 12 provided on an upper surface of the case 11; and a double-sided adhesive, light shielding film 13A provided between the upper surface of the case 11 and the dustproof film 12.

The case 11 is configured with a box-type casing (metal casing), which is made of a thin metal plate that is thin, yet capable of shielding and sealing the inside. In the upper surface of the case 11, a circular hole 11a having a diameter d1 for passing incident light is formed as a first circular hole at a position corresponding to the focusing lens 2.

The dustproof film 12 is configured with a thin plate member such as a transparent acrylic plastic material.

The light shielding sheet 13A is a black colored adhesive sheet that has adhesiveness on both sides and shields light. A circular hole 13b having a diameter d2 (d2<d1) is provided as a second circular hole concentrically with the circular hole 11a at the center of the upper surface of the case 11. In addition, the inner circumference surface of the circular hole 13b of the light shielding sheet 13A is configured with a taper surface 13c, which reduces its diameter towards the incident direction of light (or a taper surface 13c, which increases its diameter towards the outside). As described above, the light shielding sheet 13A is configured in a taper shape, in which the inner circumference surface of the circular hole 13b opens outwardly. The taper surface 13c reflects light from the outside back to the outside so as to prevent reflection of light towards the inside. The circular hole 13b is set to have an appropriate opening diameter in view of the optical characteristics of the lens, so that the light shielding sheet 13A prevents incident light from entering obliquely to prevent a flare from occurring. Further, the material to prevent reflection used for the light shielding sheet 13A is plastic, and is configured to further prevent the reflection of light from the inner circumference surface of the circular hole 13b.

The light shielding sheet 13A is a square or rectangle in a plan view, and is formed with a taper surface 13d in the periphery. In this case, the dustproof film 12 can be configured one size smaller than the light shielding sheet 13A, so that a configuration with complete beveling is provided as illustrated in FIG. 4. As a result, the dustproof film 12 will be more difficult to be peeled off from the light shielding sheet 13A due to the catching of a corner portion of the dustproof film 12.

With the configuration described above, the opening diameter of the circular hole 13b is appropriately adjusted as illustrated in FIG. 3 so that the light shielding sheet 13A, which is a black color adhesive sheet, prevents the reflection of light from a metal casing (the circular hole 11a of the metal case 11) as well as narrows the route for light so as to prevent incident light from obliquely entering, thereby preferably preventing the deterioration of image quality due to a flare. A flare is prevented by the light shielding sheet 13A. Therefore, the opening diameter of the sensor module (camera module) or the casing thereof is not required to be changed even when the characteristics of the focusing lens 2 is changed and the incident angle of the light is changed to produce such a flare. All that is required is to change the opening diameter of the light shielding sheet 13A. As a result, the design can be changed at a low cost.

### Embodiment 3

In Embodiments 1 and 2, a black color adhesive sheet is used as the light shielding sheet 13 or 13A. In Embodiment 3, it will be described that coloring variation (patterning) is added to the black color of the black color adhesive sheet, as a light shielding sheet 13B.

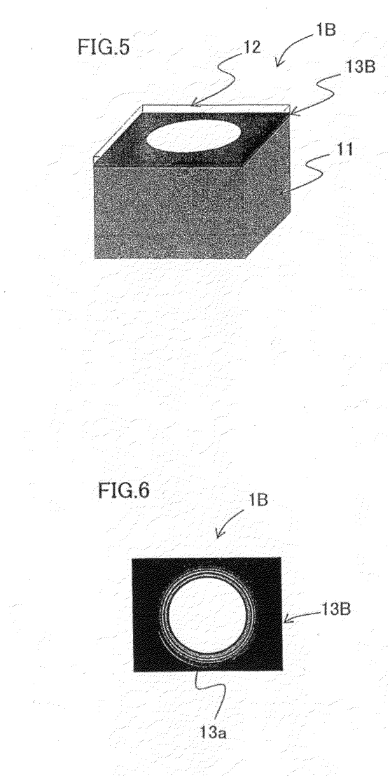

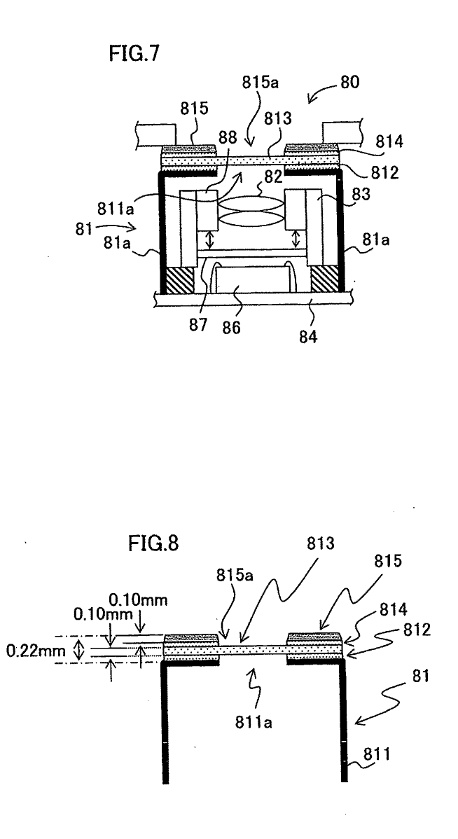

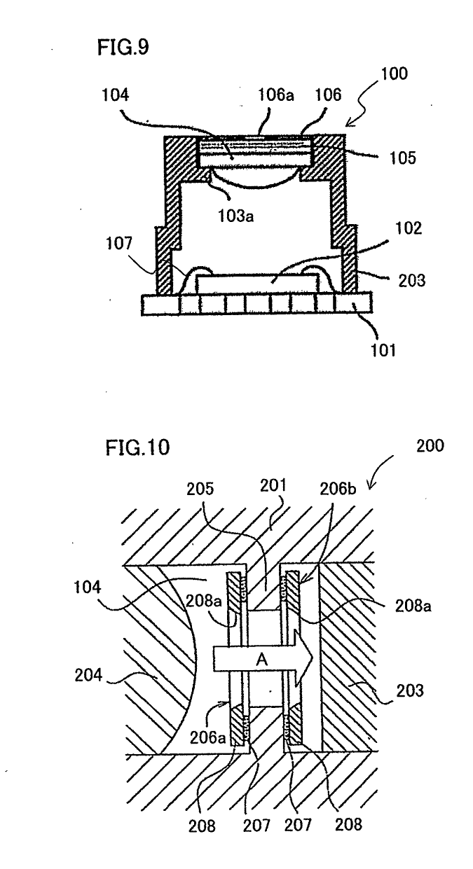

FIG. 5 is a perspective view schematically illustrating an exemplary essential structure of a case member used for a sensor module according to Embodiment 3 of the present invention. FIG. 6 is a plan view of the case member in FIG. 5. In FIGS. 5 and 6, note that the same reference numeral is denoted as the member in FIG. 1 for a member that has the same function and effect. In addition, the configuration of the sensor module 10 in FIG. 1 can be applied to the case in FIGS. 5 and 6.

In FIGS. 5 and 6, a dustproof case member 1B in a sensor module according to Embodiment 3 includes a case 11 for covering a focusing lens 2, a VCM (voice coil motor) 3, a solid-state image capturing chip 6 and an IR cut filter 7 further thereabove, with a substrate 4 to seal the inside; a dustproof film 12 provided on an upper surface of the case 11; and a double-sided adhesive, light shielding film 13B provided between the upper surface of the case 11 and the dustproof film 12.

The case 11 is configured with a box-type housing (metal housing), which is made of a thin metal plate that is thin, yet capable of shielding and sealing the inside. In the upper surface (predetermined surface) of the case 11, a circular hole 11a for passing incident light is formed at a facing position corresponding to the focusing lens 2.

The dustproof film 12 is configured with a thin plate member such as a transparent acrylic plastic material.

The light shielding sheet 13B is a black colored adhesive sheet that has adhesiveness on both sides and black in color. A circular hole 13a is provided concentrically with the circular hole 11a at the center of the case 11. The periphery of the circular hole 13a of the light shielding sheet 13B has a black colored variation. For example, a single black color becomes thinner (or darker) incrementally or continuously in a plurality of concentric circles. As a result, when the color becomes thinner, the circular hole 13a looks concaved. Alternatively, when the color becomes darker, the circular hole 13a looks protruded.

In Embodiment 3 with the configuration described above, the coloring variation is added to the black color of the black color adhesive sheet as the light shielding sheet 13B. Therefore, in addition to the function as the black color adhesive sheet, the fine appearance of the quality is added to the module. In Embodiment 1 described above, the reduction of the thickness has been described (low profiling). In Embodiment 2 described above, the prevention of a flare (the size of the circular hole) has been described, in addition to the matter described in Embodiment 1, to describe the performance/specifications. As described in Embodiment 3, the coloring of the black colored adhesive sheet has a variation, so that it is added with a value of an appearance. Although a case of adding a continuous or incremental gradation has been described to make the sheet look three-dimensional, other pattern or finer pattern may be added to provide a desirable appearance which is not processed with the conventional housing. Such an appearance can be obtained merely by changing the printing of the black colored adhesive sheet, which can be achieved at a significantly lower cost compared to the changing of the housing itself.

In Embodiment 3, the concentric and incremental variation of the coloring has been described for the black colored adhesive sheet. Without the limitation to this, a plurality of concentric stripes may be added to the coloring of the black colored adhesive sheet. Although the black color is the most appropriate in terms of preventing the reflection, other dark colors may also be used such as dark red and dark brown. In addition, the light shielding sheet 13 may be treated with other reflection prevention treatments so as not to loose the quality (appearance) of the camera module. This reflection prevention treatment may be with a single color (single tone) or with a plurality of colors, and further with various patterns.

### Embodiment 4

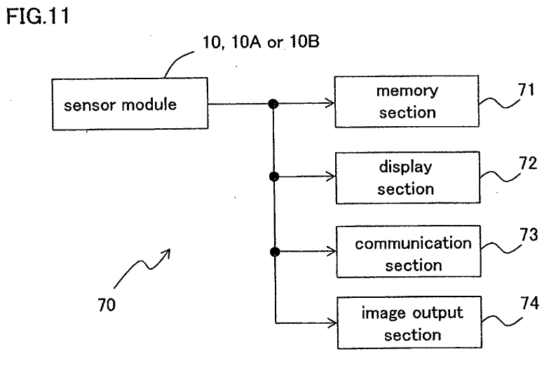

FIG. 11 is a block diagram illustrating an exemplary diagrammatic structure of an electronic information device, such as car-mounted camera and camera-equipped cell phone device, as Embodiment 4 of the present invention, using the sensor module according to any of Embodiments 1 to 3 of the present invention as an image input device in an image capturing section.

In FIG. 11, the electronic information device 70 according to Embodiment 4 of the present invention includes: any of the sensor modules 10, 10A (Embodiment 2) or 10B (Embodiment 3) according to Embodiments 1 to 3; a memory section 71 (e.g., recording media) for data-recording the color image signal from the sensor modules 10, 10A or 10B after a predetermined signal process is performed on the color image signal for recording; a display section 72 (e.g., a color liquid crystal display apparatus) for displaying the color image signal from any of the sensor modules 10, 10A and 10B on a display screen (e.g., liquid crystal display screen) after a predetermined signal processing is performed on the color image signal for display; a communication section 73 (e.g., a transmitting and receiving device) for communicating the color image signal from any of the sensor modules 10, 10A and 10B after predetermined signal processing is performed on the color image signal for communication; and an image output section 74 for printing the color image signal from any of the sensor modules 10, 10A and 10B after predetermined signal processing is performed for printing. Thus, the electronic information device 70 according to Embodiment 4 may include all of the memory section 71, the display section 72, the communication section 73, and the image output section 74. Without any limitations to this, the electronic information device may include at least any of these sections.

An electronic information device that has an image input device is conceivable, as the electronic information device 70, such as a digital camera (e.g., digital video camera and digital still camera), an image input camera (e.g., a monitoring camera, a door phone camera, a camera equipped in a vehicle (for back view or monitoring), and a television telephone camera), a scanner, a television telephone device, a facsimile machine and a camera-equipped cell phone device.

Therefore, according to Embodiment 4 of the present invention, the color image signal from the sensor module 10, 10A or 10B can be: displayed on a display screen finely; printed out on a sheet of paper using an image output section 74; communicated finely as communication data via a wire or a radio; and stored finely at the memory section 71 by performing predetermined data compression processing, and various data processes can be finely performed.

According to Embodiments 1 to 3 with the configuration above, in the sensor module 10, 10A or 10B having a moving part inside and an AF function, the dust-preventing film 12 is adhered on an upper surface of the case 11 using the double-sided adhesive sheet (light shielding sheet 13, 13A or 13B), instead of adhering two films of a dustproof film and a light shielding film accurately on such an upper surface of the case 11 as in a conventional way, so as to achieve reducing the man-hour and the cost as well as achieving low profiling and downsizing. Further, the circular hole 13a for passing incident light, which has a diameter smaller than the diameter of the circular hole 11a of the case 11, is provided at the center portion in a concentric circle manner with the circular hole 11a, so that the reflection of light can be prevented from the inner circumference side surface of the circular hole 11a of the dustproof case 11 to the inside, thereby preferably controlling a flare.

In Embodiments 1 to 3 described above, the light shielding sheet 13, 13A or 13B has been configured with a black color for a reflection preventing treatment. Without the limitation to this, the color may be other dark colors (such as dark red and dark brown). The surface may be configured with unevenness (aventurine form).

Further, in Embodiments 1 to 3 described above, the light shielding sheet 13 has been in a single black color or with a pattern. As such a pattern, the single black color becomes incrementally or continuously thinner or darker in a multiple concentric circle manner. However, without the limitation to this, a plurality of concentric circles having different diameters may be drawn as a pattern in a striped appearance. The color of the pattern may be arbitrary, and the pattern may be a geometric pattern.

Further, in Embodiments 1 to 3 described above, the circular hole 11a for passing light is defined as the first circular area of a predetermined surface (upper surface) of the case body, and the circular hole 13a for passing light, having a diameter for preventing the occurrence of a flare, is defined as the second circular area of the light shielding sheet 13. However, without the limitation to this, a transparent first circular area for passing light may be defined as the first circular area of the predetermined surface (upper surface) of the case body. In addition, a transparent second circular area for passing light, having a diameter for preventing the occurrence of a flare, may be defined as the second circular area of the light shielding sheet 13.

Further, in Embodiments 1 to 3 described above, it has been described that the case 11 described above is a metal casing provided with an upper surface and four side surfaces connected to the upper surface, and the lower surface is open. Without the limitation to this, the casing may be a metal cylindrical shape.

Further, although not specifically described in Embodiments 1 to 3 described above, at least the solid-state image capturing chip 6 provided on the substrate 4, for performing photoelectric conversions on and capturing image light from a subject, may be encased by the case member 1 and the substrate 4 inside the case member 1 to be sealed as a sensor module. Further, in addition to this, a moving part capable of driving the focusing lens 2 close to and far away from the image capturing area in order to adjust the focal point to the image capturing area of the solid-state image capturing chip 6, as well as a driving section for driving the moving part may be included. The moving part and the driving section may be encased inside the case member 1 to be sealed. Further, in addition to this, the infrared rays cut filter 7 for cutting the infrared rays from incident light may be provided in such a manner to cross between the solid-state image capturing chip 6 and the moving part, and the infrared rays cut filter 7 may be encased inside the case member 1 to be sealed.

As described above, the present invention is exemplified by the use of its preferred Embodiments 1 to 4. However, the present invention should not be interpreted solely based on Embodiments 1 to 4 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 4 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a sensor module equipped with a solid-state image capturing chip for performing photoelectric conversions on and capturing image light from a subject, a case member used for the sensor module, and an electronic information device, such as a digital camera (e.g., digital video camera and digital still camera), an image input camera (e.g., an onboard camera), a scanner, a facsimile machine, and a camera-equipped cell phone device, using the sensor module as an image input device in an image capturing section. According to the present invention, a transparent dust-preventing film is adhered on such a predetermined surface of the case body using the double-sided adhesive light shielding sheet so as to achieve reducing the man-hour and the cost as well as achieving low profiling and downsizing, as compared to the conventional way. Further, the second circular area of the light shielding sheet is located above the first circular area of the case body, and the diameter of the second circular area of the light shielding sheet is smaller than the diameter of the first circular area of the case body, so that the reflection of light can be prevented from the inner circumference side surface of the first circular area of the case body.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A case member having a predetermined surface and a sealable inside;
wherein a first circular area for passing light is provided at the center portion of the predetermined surface,
wherein a double-sided light shielding sheet, which is provided with a second circular area for passing light at the center, is adhered to the predetermined surface such that the second circular area is positioned in a concentric circular manner to the first circular area, the second circular area having a diameter smaller than the diameter of the first circular area, and
wherein a transparent dustproof film is adhered on the light shielding sheet.

2. A case member according to claim 1, wherein the light shielding sheet has a reflection preventing function.

3. A case member according to claim 1, wherein the light shielding sheet is in a black color or a dark color.

4. A case member according to claim 1, wherein the light shielding sheet is configured with a surface having an uneven form for diffused reflection.

5. A case member according to claim 1, wherein the light shielding sheet is in a single color or is drawn in a pattern.

6. A case member according to claim 5, wherein the pattern is such that the single black color becomes incrementally or continuously thinner or darker in a multiple concentric circle manner.

7. A case member according to claim 5, wherein the pattern is such that a plurality of concentric circles having different diameters are drawn in a striped appearance.

8. A case member according to claim 1, wherein the first circular area and/or the second circular area is a first circular hole for passing light.

9. A case member according to claim 1, wherein the first circular area and/or the second circular area is a transparent first circular area for passing light.

10. A case member according to claim 1, wherein the second circular area of the light shielding sheet is a second circular hole for passing light that has a diameter for preventing the occurrence of a flare.

11. A case member according to claim 1, wherein the second circular area of the light shielding sheet is a transparent second circular area for passing light that has a diameter for preventing the occurrence of a flare.

12. A case member according to claim 10, wherein an inner circumference surface of the second circular hole of the light shielding sheet is configured with a taper surface that reduces its diameter in a direction to which incident light enters.

13. A case member according to claim 1, wherein the sum of the thicknesses of the light shielding sheet and the dustproof film is configured to be equal to or thinner than 0.22 mm.

14. A case member according to claim 13, wherein the thickness of the light shielding sheet is in the range of 0.03 to 0.10 mm.

15. A case member according to claim 13, wherein the thickness of the dustproof film is in the range of 0.05 to 0.15 mm.

16. A case member according to claim 1 having a case which is a metal box or metal cylinder.

17. A case member according to claim 16, wherein the predetermined surface is an upper surface of the case, the upper surface and four side surfaces connected to the upper surface are provided, and a lower surface is open.

18. A sensor module including a solid-state image capturing chip provided on a substrate, for performing photoelectric conversions on and capturing image light from a subject, the solid-state image capturing chip encased inside the case member to be sealed by the case member and substrate according to claim 1.

19. A sensor module according to claim 18, further including a moving part capable of driving the focusing lens close to and far away from the image capturing area in order to adjust the focal point to the image capturing area of the solid-state image capturing chip, and a driving section for driving the moving part.

20. A sensor module according to claim 19, being provided with an infrared rays cut filter for cutting infrared rays from incident light from the focusing lens in such a manner to cross between the solid-state image capturing chip and the moving part.

21. An electronic information device using the sensor module according to claim 18 as an image input device in an image capturing section.
